(19) United States
(12) Patent Application Publication
(10) Pub. No.: US 2010/0290365 A1
(43) Pub. Date: Nov. 18, 2010

(54) MULTI-LEVEL HOSTED INBOUND ADMINISTRATION FOR A TELEPHONY SYSTEM

(76) Inventors: Andrew W. Kwong, Naperville, IL (US); John A. Nix, Evanston, IL (US); Zachary Eleveld, Gurnee, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/448,587

(22) PCT Filed: Dec. 22, 2005
(86) PCT No.: PCT/US05/47003

§ 371 Date: May 25, 2010

Related U.S. Application Data
(60) Provisional application No. 60/639,161, filed on Dec. 22, 2004.
(60) Provisional application No. 60/643,398, filed on Jan. 12, 2005.

(51) Int. Cl. H04L 12/66

(52) U.S. Cl. 370/254; 370/352

(57) ABSTRACT

A multi-level hosted inbound administration platform for a packet-switched telephony system is provided. The platform provides services for managing the distribution and features of direct inward dialing numbers (DIDs). The platform allows a client to import or purchase DIDs, make DIDs available to sub-distributors, and provision them to end-users. The platform allows sub-distributors to reserve and activate DIDs, make DIDs available to downstream sub-distributors, and provision them to end-users. The platform provides a billing structure for DID usage, with charges being applied on a one-time, monthly, or variable basis. The platform also allows clients and sub-distributors to charge for inbound services based on per-minute or per-usage charges.

### RELATED APPLICATIONS

This application claims the benefit under 35 U.S.C. §119(e) of U.S. Provisional Application No. 60/639,161, filed Dec. 22, 2004, and U.S. Provisional Application No. 60/639,864, filed Jan. 12, 2005, both of which are incorporated by reference herein in their entirety.

### FIELD

The present invention relates to the field of packet-switched telephony systems. More specifically, the present invention relates to multi-tiered hosted administration platforms for managing packet-switched telephony systems.

### BACKGROUND

Voice over Internet Protocol (VoIP) services, or Internet telephony services, allow users to make standard telephone calls using a data network, rather than a circuit-switched system, as the main call transferal medium. In a VoIP system, the analog voice signal from a receiver is converted to one or more digital data packets which are routed through the packet switched data network in the same manner as an e-mail message. The receiver may be a standard analog telephone connected to an analog telephone adaptor (ATA), an internet protocol (IP) phone that connects directly to a broadband connection through an Ethernet port, or a computer with a microphone and appropriate software that also has access to a broadband Internet connection. Alternatively, the receiver may be an analog or digital phone connected to a private branch exchange that converts the voice signal to data packets for transmission over a packet switched network.

In order to place a call using VoIP services, a user may require the use of a packet-switched telephony network provided by a telephony service provider (TSP). The provider may be a local plain old telephone service (POTS) provider with access to the Internet, or an internet service provider (ISP) or VoIP service provider with service agreements with local or global telephony service providers. Generally, prior to using the packet-switched telephony network to place or receive telephone calls from the public switched telephone network, a user for VoIP services may need to create an account with the TSP. Once an account has been created, the user may connect a VoIP device to the network, configure the VoIP device for use with the TSP infrastructure, and then proceed to make outbound calls with the VoIP device while incurring any charges to the user account.

In assessing charges to a user account for outbound calls, a TSP may utilize an outbound administrative platform that provides account management and billing services. These platforms may handle account management by permitting the TSP or an end-user to remotely create accounts, for example via a web interface. For billing services, these platforms may allow the TSP to set costs for calls to locations on a per-use, per-minute, or per-month basis, as well as for various other services. End-users may be able to transfer credit from a credit or bank account into their TSP account, and otherwise manage funds associated with the VoIP account. A client may manually log in to an account via a web interface in order to use the TSP services, or associate a user account with a VoIP device. Thereafter, the TSP infrastructure may then monitor any calls made from the account and report the usage to the administrative platform. The associated client account may then be adjusted to account for the costs associated with these calls along with any other fees.

Additionally, the outbound administrative platform may provide a client with the ability to resell the services provided by the TSP infrastructure. A client may create a master account and then provision end-user accounts that can utilize the VoIP services of the TSP. In this setup, the client may obtain wholesale rates for outbound services from the TSP and then resell these services to downstream sub-distributors or end-users with a markup.

In order to provide a complete suite of management tools for a TSP that offers bi-directional services, it is also necessary to provide support for inbound calling services. Providing inbound services requires the ability to provide and manage telephone numbers, or direct inward dialing numbers (DIDs), through which an end-user can receive inbound calls. These DIDs may originate from any country, and can thereby allow an end-user to project a virtual presence from nearly anywhere in the world. The DIDs are generally maintained and provisioned by a TSP or more specifically by a local service provider on behalf of the TSP from the country that the DID originates. As the DID provides a number that an end-user can receive inbound calls in a similar fashion to that of a standard telephone number, the DID may also be associated with certain telephony features such as voicemail, caller ID, call forwarding, and call hunting. Indeed, in a preferred embodiment, the DID is a standard telephone number, for use with VoIP.

Because inbound services provide a separate set of variables than outbound services, a modified administrative platform is required to effectively manage this system. It would be desirable for such an inbound services administrative platform to provide support for distribution and management of DIDs and their associated features. This distribution should allow for a multi-tiered distribution of DIDs to allow for flexibility in reselling TSP services. It would be desirable for the platform to provide multiple billing options, such as per-minute, per-usage, or per month fees. Additionally, it would also be desirable for an inbound services administrative platform to be capable of managing toll-free numbers in addition to DIDs. Each tier of the distribution network for the VoIP service with DIDs may also have the option to set their own rates for services sold to the next level in the distribution network, with the final tier selling to the end user or enterprise setting the retail rates.

### BRIEF DESCRIPTION OF THE DRAWINGS

Exemplary embodiments of the invention are described below in conjunction with the appended figures, wherein like reference numerals refer to like elements in the various figures, and wherein:

FIG. 1 is an illustration of a management structure for internet protocol (IP) telephony services distribution, according to an exemplary embodiment;

FIG. 2 is an illustration management platform login interface, according to an exemplary embodiment;

FIG. 3 is an illustration of an interface for purchasing DIDs, according to an exemplary embodiment;

FIG. 4 is an illustration of an interface for uploading DIDs from a third-party service provider, according to an exemplary embodiment;

FIG. 5 is an illustration of an interface for providing DIDs for sale to a sub-distributor, according to an exemplary embodiment;

FIG. 6 is an illustration of an interface for managing DID availability, according to an exemplary embodiment;

FIG. 7 is an illustration of a management structure for direct inward dialing number (DID) distribution, according to an exemplary embodiment;

FIG. 8 is an illustration of an interface for provisioning a DID to an end-user account, according to an exemplary embodiment;

FIG. 9 is an illustration of a first interface for creating an end-user account, according to an exemplary embodiment;

FIG. 10 is an illustration of a second interface for creating an end-user account, according to an exemplary embodiment;

FIG. 11 is a process flowchart for end-user DID self-provisioning where the end-user does have an active account, according to an exemplary embodiment;

FIG. 12 is a process flowchart for end-user DID self-provisioning where the end-user does not have an account, according to an exemplary embodiment;

FIG. 13 is an illustration of a first interface for managing features associated with a DID, according to an exemplary embodiment;

FIG. 14 is an illustration of a second interface for managing features associated with a DID, according to an exemplary embodiment;

FIG. 15 is an illustration of a DID distribution and billing structure, according to an exemplary embodiment;

FIG. 16 is an illustration of an interface for creating a DID service plan, according to an exemplary embodiment;

FIG. 17 is an illustration of an interface for creating a DID billing account cycle, according to an exemplary embodiment;

FIG. 18 is an illustration of an interface for searching for accounts by personal identification number (PIN), according to an exemplary embodiment;

FIG. 19 is an illustration of an interface for examining results returned by searching for accounts by PIN, according to an exemplary embodiment;

FIG. 20 is an illustration of an interface for searching for accounts by DID, according to an exemplary embodiment;

FIG. 21 is an illustration of an interface for examining results returned by searching for accounts by DID, according to an exemplary embodiment;

FIG. 22 is an illustration of an interface for creating and printing a batch of top-up cards, according to an exemplary embodiment;

FIG. 23 is an illustration of an interface for an end user to manage the features of their account including the option to “add a phone number” according to an exemplary embodiment;

FIG. 24 is an illustration of an interface for an end user to enter an authorization code to add a DID telephone number to the end user account, according to an exemplary embodiment;

FIG. 25 is an illustration of an interface for an end user to request the parameters for which DID telephone number will be assigned to the end user account;

FIG. 26 is an illustration of an interface for an end user to receive confirmation of the DID telephone number assigned to the end user account; and

FIG. 27 is an illustration of an interface for an end user to receive confirmation of the billing parameters for the DID telephone number assigned to the end user account.

### NOTE ON TERMINOLOGY

Unless otherwise stated, the telephony service provider (TSP) refers to the entity providing the hosted inbound administrative platform. Additionally, unless otherwise stated, a distributor refers to any reseller of TSP services, a client refers to a distributor of inbound services that has created a user account directly with the TSP, and a sub-distributor refers to a distributor of inbound services that has an account with either the client or another sub-distributor. An end-user refers to an entity that utilizes the inbound calling services provided by the TSP and does not re-sell these services to another entity.

### DETAILED DESCRIPTION

### 1. Overview

In order to properly and completely manage bi-directional telephony services, it is necessary to provide a suite of tools that allow configuration of inbound services in addition to outbound services. Generally, outbound services permit a user to initiate outbound calls from a general telephony device. However, in order to supply inbound telephony services for calls utilizing the PSTN, it is necessary for a telephony service provider to provide an end-user with a unique telephone number, or direct inward dialing (DID) number, with which the end-user can receive inbound calls. The DID telephone number may be dialed from any subscriber of the public switched telephone network, or directly from other VoIP devices if the DID is enabled with a public VoIP registration protocol such as ENUM. The DID number may be a standard telephone number or it may also be more like a “virtual” DID, in which extension-like numbers are provided to allow additional VoIP users to be reached from one standard telephone number.

The current invention provides a hosted multi-tiered administration platform that permits a client to manage the cost and functionality of inbound packet-switched telephony services. The platform allows a telephony service provider (TSP) to create multi-tiered lateral and vertical distribution networks, access direct-inward-dialing numbers (DIDs) and provision them to various sub-distributors and eventually to end-users, perform downstream markups of telephony services, affect calling rates and surcharges that apply to each level of the distribution network and individual nodes in the network, and otherwise manage the entire distribution and payment chain relating to inbound telephony services. The end-users may have these DIDs assigned to voice over internet protocol (VoIP) enabled telephony transceiver, such as a computer, an internet protocol (IP) phone, or a public switched telephone network phone connected to an IP gateway, such as an analog telephone adaptor (ATA). An internet telephony system may then allow phone calls initiated using the PSTN or VoIP to be routed by a routing device, such as a session initiation protocol (SIP) proxy server, to associate a called number (e.g. DID number) with a MAC address or other identifier of the receiving VoIP device. The IP address may then be determined and the call routed to that device.

The administration platform manages access and billing rates of inbound services provided by a TSP. The TSP may create a master account for the client that enables the client to create a multi-tiered lateral and vertical distribution network to manage inbound calling services. Using the platform, a client is able to purchase and provision DIDs from the telephony service provider and manage their use and distribution. Additionally, DIDs may be purchased from an outside, or third-party, provider and then imported into the administration platform for management and distribution in the same manner as the service provider-obtained DIDs. DIDs within the administration platform may then be made available for use by sub-distributors or end-users in the distribution network. DIDs are provisioned to end-user and sub-distributor devices, which are capable of receiving inbound telephone calls from either the PSTN or through VoIP at the provisioned number. The administration platform allows the master account and sub-distributor accounts to decide which services will be provided with each provisioned DID, and allows for a billing structure to be created for specific DIDs or sub-distributors. In addition to these downstream service allocation and billing functions, the administration platform may also include several customer support and account management tools, which may also be provisioned with associated fees.

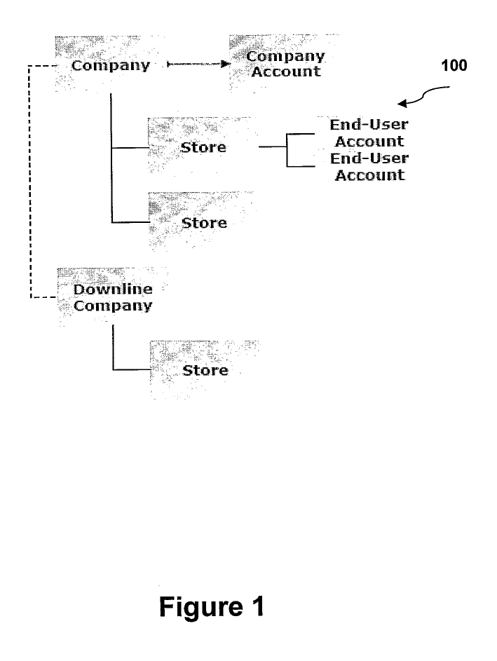

Through the use of the administrative platform a telephony service provider may allow a client to access to a telephony services infrastructure, and also allow a client to be a reseller of the inbound calling services offered by the telephony service provider. The client may use the resources of the administrative platform to acquire DIDs, activate and reserve DIDs, create sub-distributor accounts, manage the funds associated with sub-distributor accounts, control the administrative features available to each sub-distributor account, provision DIDs to sub-distributor accounts, control the features available to each group of DIDs or each individual DID, and control the costs for accessing DIDs and utilizing the various DID features. Additionally, a sub-distributor may use the resources of the administrative platform to acquire DIDs, activate and reserve DIDs, provision DIDs to downstream sub-distributor accounts, control the features available to provisioned DIDs, control the administrative features available to downstream sub-distributor accounts that have acquired DIDs from the sub-distributor, provision DIDs to end-users, configure DIDs provisioned to end-users, and control both the costs of DIDs provisioned to downstream sub-distributors and end-users and the various costs assigned to the features of these DIDs. Using the above capabilities, a client may create a multi-tiered distribution network 100 of incoming telephony services provided by the telephony service provider, such as shown in FIG. 1. Additionally, the client may create a multi-level network to control the downstream billing of these services and the distribution of DIDs. The administrative platform can be created so that a sub-distributor at any level of the distribution network has full access to all the administrative tools, and may appear to be a direct customer of the telephony service provider. Consequently the sub-distributor does not need to know his or her specific level of the distribution network.

One feature of the administration and provisioning of DID based VoIP services according to one embodiment is the reservation and billing for DIDs before the provisioning to the end user. A client may wish to reserve a DID or a group of DIDs in preparation for adding new end users or sub-distributors. For example, a business may wish to reserve a certain range of numbers that differ in only the last three numbers. By reserving the range, the business is able to avoid having to activate and pay for full use of the range until the numbers in the range are actually needed. Since the TSP may have a cost for provisioning DIDs and creating the inventory within the administrative platform, a periodic charge can be placed for DIDs to be reserved but not allocated or activated with end users. Clients can use the administrative system to pass the monthly charge for inactive but reserved DIDs to their sub-distributors or even end users. Such a system of charging for reserved but inactive DIDs may help maintain efficient distribution.

The platform may be part of a comprehensive management platform that includes outbound service administration, thereby providing the capability to oversee and direct the access to a full suite of bi-directional telephony services. Alternatively, the inbound administration platform may be used as a standalone tool to manage an infrastructure or business plan directed to inbound services. For outbound services, each level in the distribution network may use the administrative platform to set rates and fees for outbound services that are sold to the next level of the distribution network or end users.

### 2. Platform System

The inbound administration platform interfaces with the telephony service infrastructure of the provider. The packet-switched telephony infrastructure provides an interface between the general packet-switched network and local IP or telephony networks on which the end-user telephony device resides. The general packet-switched network acts as the medium over which the telephony data travels between the end-user telephony device and the source of the inbound telephone call. In general, this medium may be the Internet or a corporate data network. The packet-switched telephony infrastructure maintained by the telephony service provider facilitates the processing of VoIP protocols such as session initiation protocol (SIP) messages, H323, or MGCP in order to establish a connection between the end-user telephony device and the call-initiating device. Additionally, this infrastructure may incorporate local and global public switched telephone network (PSTN) and data network terminations. Through the use of SIP technology in conjunction with other VoIP technologies, it is possible for the packet-switched telephony infrastructure to accept a handoff of an inbound call from a DID provider, such as a local exchange carrier, and forward the call to a SIP compatible IP end-user device. In forwarding the call to the end-user device, the infrastructure provides the ability to determine the device's address on the data network (e.g. a network address and/or a physical address) and ring the device, assuming that the device is connected to the data network and is actively receiving calls.

The administrative platform may be comprised of several server applications, with each server performing a task related to the functionality of the platform. The server applications may comprise a web server, an application server, a remote authentication dial in user service (RADIUS) server, a file transfer protocol (FTP) server, and a database. These servers may reside on one or more computer systems, where each computer system is supported by an operating system. This operating system may be an open-source Linux operating system, or any other operating system that can provide file and resource management, such as Windows or Unix. The web server application may support a web interface and permit a client to access the platform from a remote location. The web server may support scripted code, such as common gateway interface (CGI), javascript, or perl. Alternatively, another scripting language may be supported that also allows hypertext markup language (HTML) code to be dynamically generated and is capable of processing user-entered information via a web interface. The web server may be an Apache web server, or another hypertext transfer protocol (HTTP) or secure HTTPS server. The application server may support web applications based on platform-independent technologies, such as Java servlet and Java server pages (JSP) technologies. The application server may be a Tomcat server, or any other server with the ability to support Java servlet and JSP applications. The RADIUS server may be used to support client authentication and authorization, and determine client configuration settings. The RADIUS server may be a readily available open-source server, such as FreeRADIUS, or any other RADIUS compatible server.

As described above, the administrative platform server applications may be hosted on one or more computer systems that are accessible by the TSP. Each computer may comprise a data network connection that allows it to receive data from and send data to remote locations. With the platform housed on these computers, a client may be able to access the platform using a device such as a personal computer with a web browser connected to the Internet and manage the inbound calling services distribution network from a remote location. Additionally, each computer may also comprise a processor capable of processing data received through the network connection, as well as a processor for encoding data to be sent out over the network to a remote location. A memory may be included in each computer, with code stored in the memory containing server application data. Additionally, the memory may be used to provide a variety of graphical user interfaces that the TSP or client may use to access the administrative services offered by the platform.

### 3. Platform DID Management

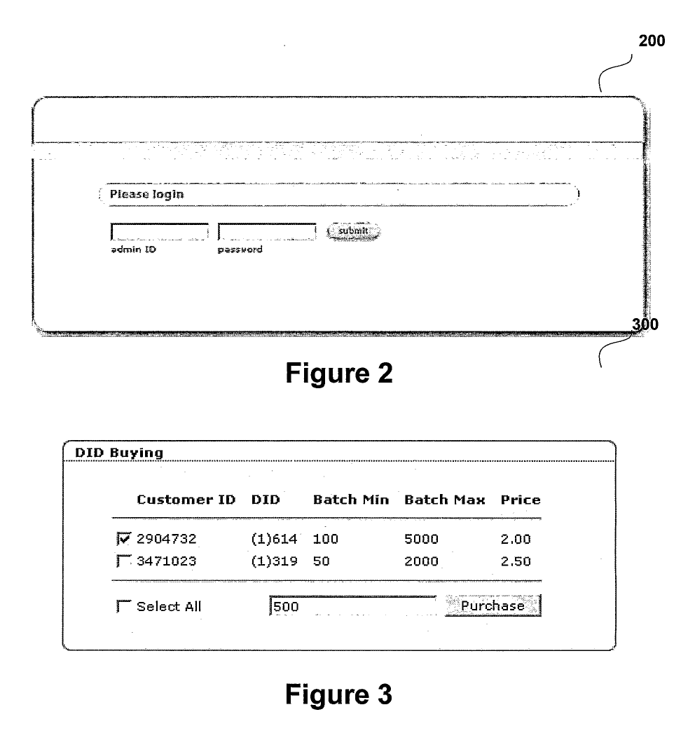

In order to access the services provided by the administrative platform, a user may remotely log into the system by directing a suitably equipped internet browser to a specified login web page, such as the page 200 shown in FIG. 2. This web page 200 may generally be hosted by the web server of the administrative platform. Additionally, this web page 200 may be generated through JSP, PHP, or ASP technology. The client may enter an assigned unique identification and a password into the login interface, and if authentication is successful, the client may be logged into the administrative platform with access to the various account management services provided to that account.

In order to utilize the inbound services provided by the management platform and allocate the DIDs to end users, a client must first obtain one or more DIDs. These DIDs may generally be acquired by one of two methods. Using one method, the telephony service provider that hosts the administrative platform may control access to batches of DIDs, which can subsequently be made available to the client. The platform may allow the telephony service provider to set costs for different batches of DIDs or for individual DIDs, and clients may then be able to purchase these DIDs through an interface 300 similar to that of FIG. 3. This interface 300 may comprise a list of customer IDs that identify the telephony service provider or sub-distributor that is selling the DIDs. Additionally, the interface 300 may comprise the area code or country code associated with the available DIDs. The interface 300 may also comprise supplemental information regarding the minimum and maximum number of DIDs that may be purchased in a single batch, along with the price for each DID. The client may select the group of DIDs that are to be purchased and also provide the number of DIDs that are desired. If the purchase request meets all restrictions regarding availability, batch size, and cost, then the DIDs may be added to the set of available DIDs for the client with the cost of the batch being deducted from the client account. If emergency services such as e911 are to be provided with the inbound DID, the physical street address of each DID may also be entered. In addition to procuring a batch of DIDs, the client can provision and procure single individual DIDs.

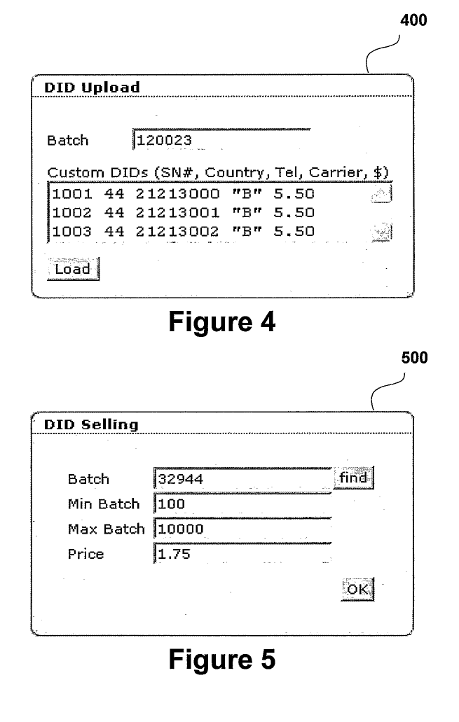

Alternatively, DIDs may be acquired by the client or subdistributor from a third-party local service provider or other telephony service provider and then uploaded into the administrative platform. This allows a client to use the platform to manage the distribution and properties of DIDs acquired from any source. Using an interface 400 similar to that of FIG. 4, a client may upload a number of third-party DIDs and assign them to a batch. The DIDs may be uploaded by entering information such as an identifying serial number, a country code for the given DID, the actual telephone number corresponding to the DID (they may be identical), the service provider from which the DID was acquired, and the price at which the DID was acquired. Once a batch of third-party DIDs have been entered into the administrative platform system by the client, these DIDs may be manipulated and managed in the same manner as those provisioned by the telephony service provider hosting the platform. Batches of DIDs may also include geographical information for the ultimate physical location such as street address or latitude and longitude in order to support emergency services.

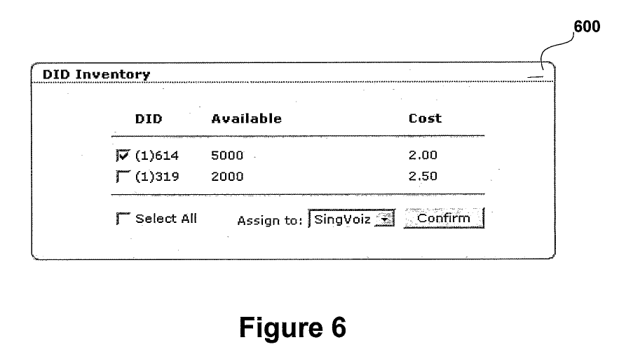

Once a client or sub-distributor has acquired an inventory of DIDs and has registered the DIDs with the administrative platform, these DIDs may be offered up for sale using an interface 500 similar to that of FIG. 5. The client or sub-distributor may select a batch of DIDs by entering in the batch number directly or by searching through a list of available DID batches. Once a batch is selected to be offered up for sale a cost may be assigned to each DID in the batch. The costs for sale may include both the cost for activated DIDs and inactive DIDs that may be in inventory of the sub distributor or inactive but assigned to the end user. Additionally, a minimum and maximum batch size may be set for DIDs offered up for sale.

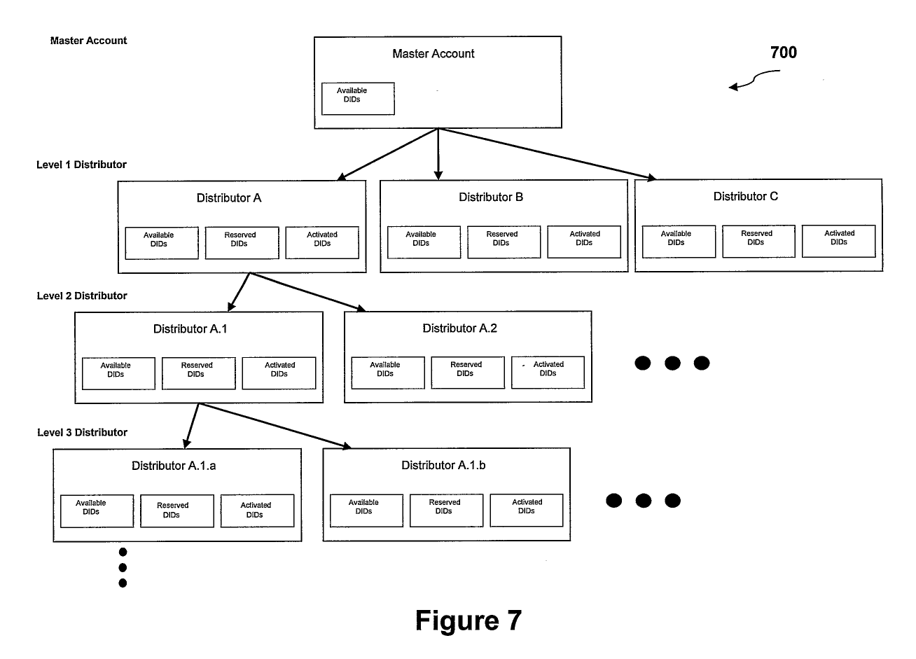

After a client or sub-distributor has acquired an inventory of DIDs, they may be offered up for sale to one or more sub-distributors using an interface 600 similar to that of FIG. 6. The client or sub-distributor may select one or more batches currently configured for sale and then determine the sub-distributors to make the selected batches of DIDs available to. The sub-distributors that are granted access may then activate or reserve batches of these DIDs. Alternatively these DIDs may in turn be made available to downstream sub-distributors who can subsequently reserve, activate, or make available the DIDs. The administration platform therefore provides a downstream administration structure 700 for DIDs as illustrated in FIG. 7. Only batches of DIDs made available by upstream sub-distributors or clients may be accessible to sub-distributors further down the provisioning chain.

A client or sub-distributor may activate a batch of DIDs that are available from an upstream provider. When a batch of DIDs is activated, the DIDs are supported by the TSP and may receive incoming calls once the DID is provisioned at the end users VoIP device. Other clients and sub-distributors may then be restricted from activating or reserving the activated DIDs. A client or sub-distributor may activate the DIDs in order to provision the DIDs to an end-user, or to provision the DIDs internally to a client or sub-distributor owned device. Alternatively, the client or sub-distributor may choose to simply reserve a batch of DIDs. When a batch of DIDs are reserved, other clients and sub-distributors may be restricted from activating or reserving the DIDs, but the TSP does not actively support telephony services on the DIDs. A client or sub-distributor may choose to reserve a batch of DIDs with the possibility of activating the batch at a later time. For example, if a company is planning on expanding its number of phone lines in the future but only requires a few phone lines at a given moment, it may choose to reserve a large batch of numbers to accommodate future growth while only activating a small portion of the DIDs to account for the telephony needs at that moment. The administrative platform may ensure that monthly charges for the inactive portion of the DIDs are deducted from the company's account.

As another alternative, an imported DID number could be purchased, provisioned, and used by lateral distributors and/or subdistributors (i.e. those at the same level) upstream and then back downstream in a different branch (i.e. a “cousin subdistributor”) or even subdistributors under a different client.

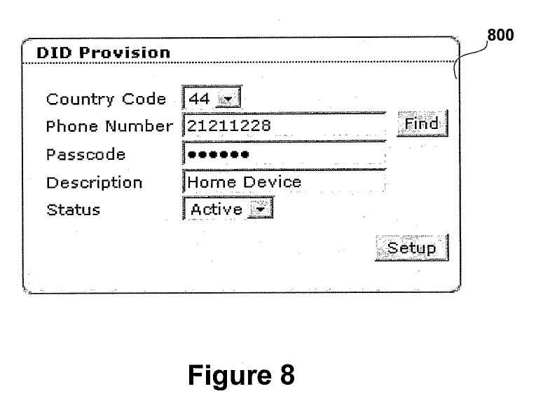

A client or sub-distributor may directly provision DIDs to an end-user account through an interface 800 similar to that of FIG. 8. Using this DID provisioning interface 800, the client or sub-distributor may select a specified country code and then search for phone numbers or DIDs that are available for that country code. A passcode may be generated to prevent an unauthorized party from utilizing the DID number, and can then be relayed to the end-user or included in the provisioning of the end user device to prevent unauthorized devices from registering to receive the inbound telephony services. A general description may also be provided for the specific DID. Additionally, the status of the DID can be set to either an active or disabled status depending on the current state of the end-user account.

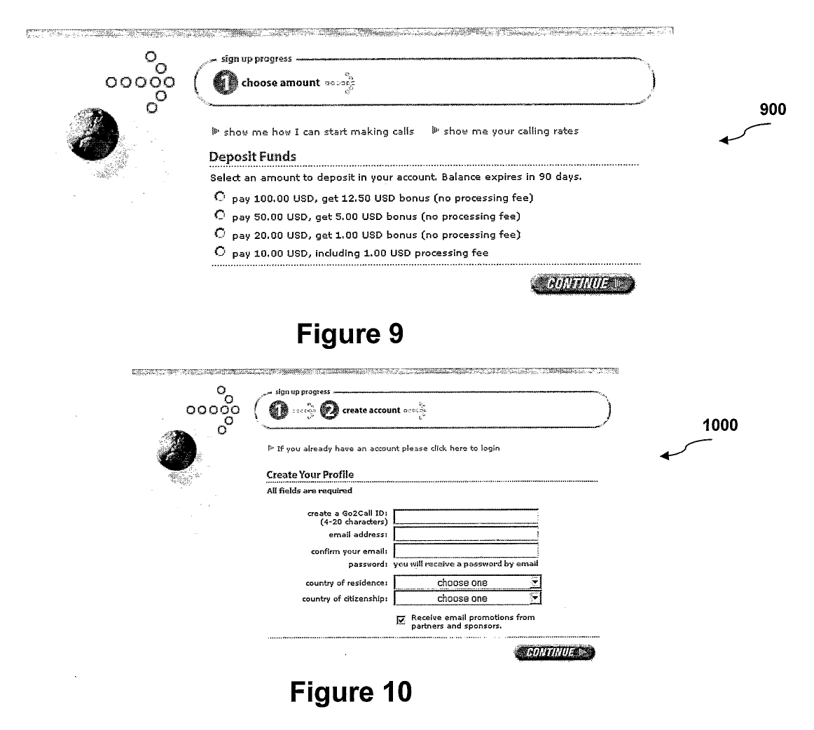

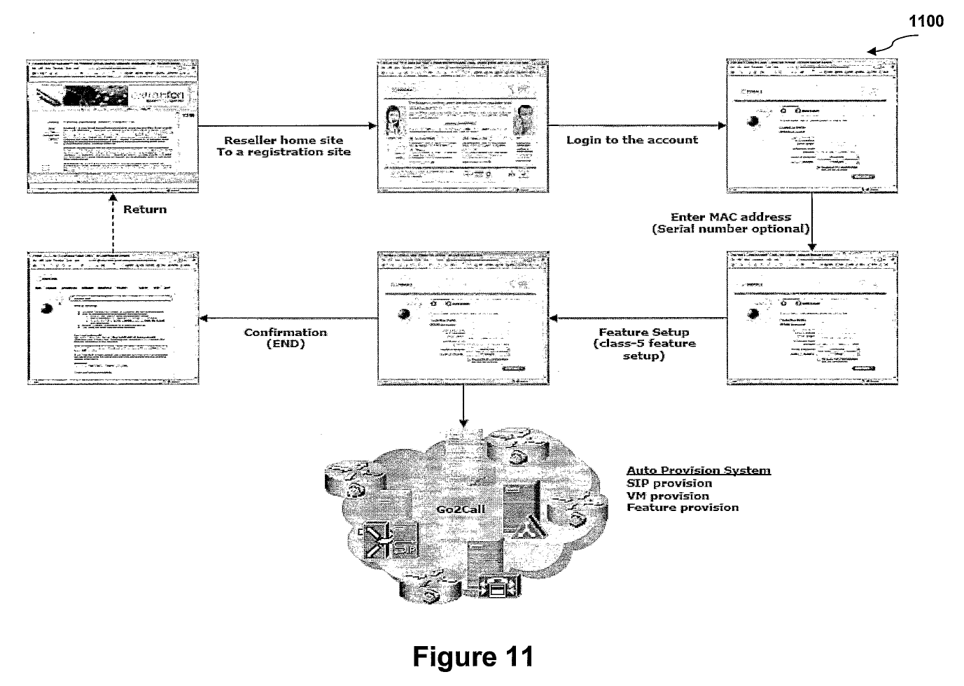

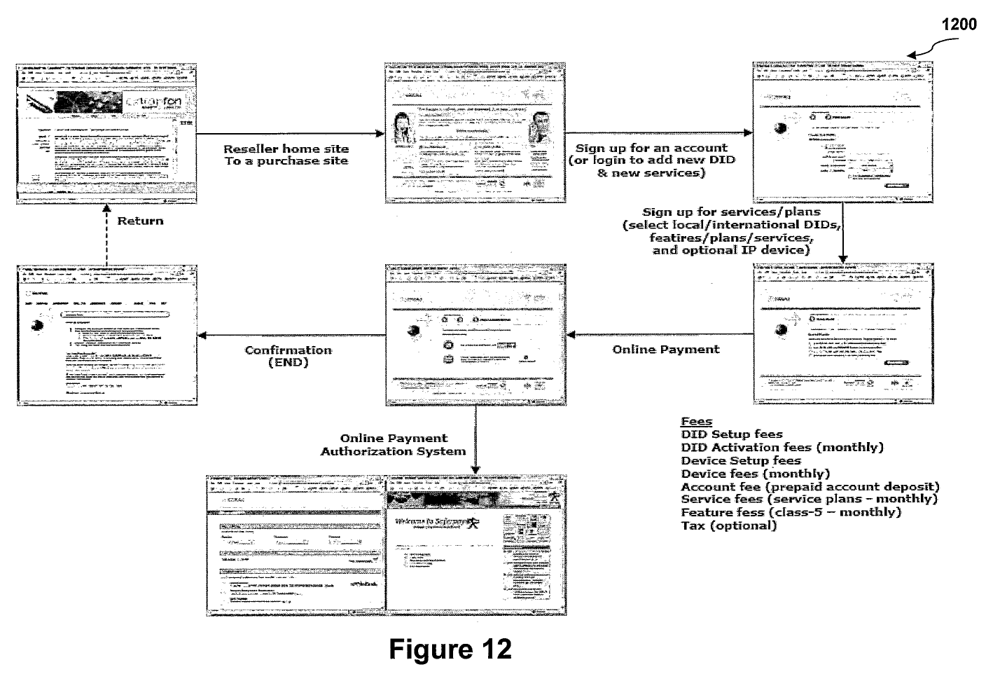

Alternatively, instead of the client or sub-distributor directly provisioning a DID to an end-user, the platform may be accessed by an end-user who can then self-provision and self-assign a DID from the TSP or the client or sub-distributor's account. An end-user may access a registration website provided by the platform and create an account using interfaces 900, 1000 similar to that of FIG. 9 and FIG. 10. The end-user may create the account for a fee, and may be required to fund the account by a minimum value in order to access any services provided by the administration platform. The end-user may fund the account through online payments or through automatic deductions from an existing credit or bank account. Once the end-user has created an account, the user may then use the platform to sign up for DID services or plans, purchase local or international DIDs, add or remove features to currently activated DIDs, or associate IP telephony hardware with a DID. In order to activate a physical IP telephony device and associate the device with a DID the end-user may need to provide such information as the media access controller (MAC) address of the device, the serial number of the device, or other personal information such as a permanent address. FIG. 11 and FIG. 12 illustrate the processes 1100, 1200 for end-user DID self-provisioning for end-users with and without accounts, respectively.

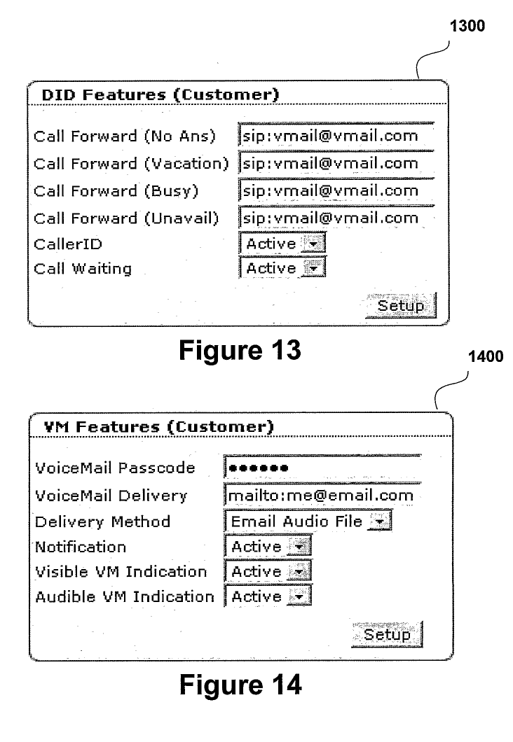

A DID may be associated with certain features such as voicemail, caller ID, call forwarding, closed user groups, call hunting, and other features. The scope and number of features available for each DID may be limited by the telephony capabilities of the TSP. Each of these features may be active or disabled for a given DID. Additionally, a set of active features may be applied to a batch of available DIDs as opposed to a single DID. For example, one batch of DIDs provisioned by the client to a sub-distributor may have the voicemail feature activated, while a second batch may have the voicemail feature disabled. Periodic charges to the account may be adjusted to reflect the number of features provisioned. The active features of the DID may be controlled by the client or sub-distributor that provisions the DID to the end-user. Management of the available DID features may be performed by a client or sub-distributor through interfaces 1300, 1400 similar to that of FIG. 13 and FIG. 14.

### 4. Inbound Billing Services

The administrative platform may also provide a billing structure that a client or sub-distributor may use to manage charges associated with the use of inbound services provided by the TSP. These charges may include those associated with purchasing, selling, reserving, activating, and provisioning DIDs. Additionally, the platform may manage the costs associated with individual DIDs, such as general service fees, long distance fees, per-minute fees, per-usage fees, service plan fees, and feature fees. The platform may also provide the ability to bill downstream management tools such as monthly usage statistics, and other reports.

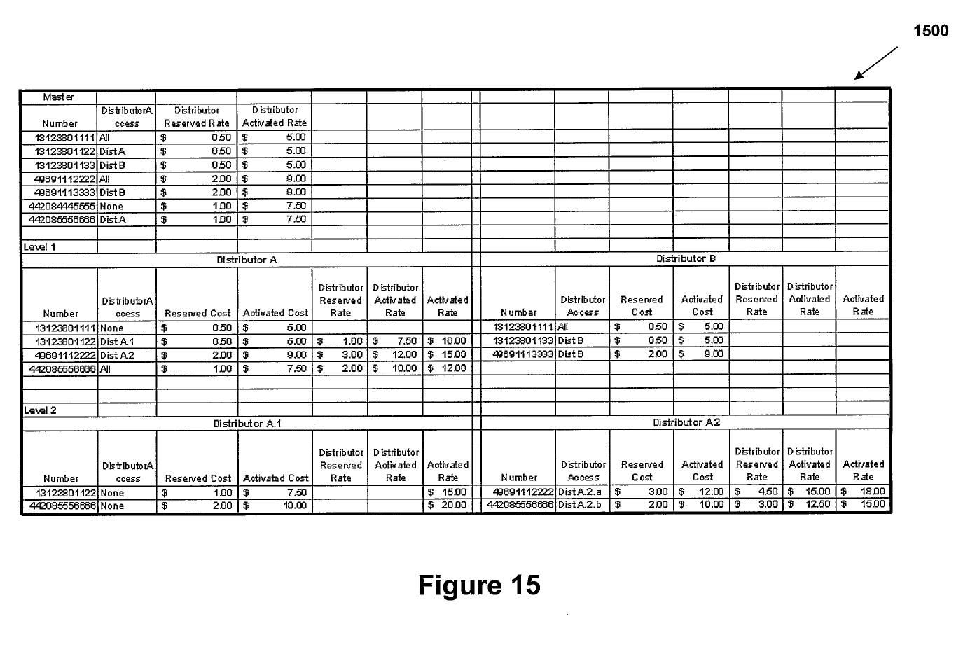

The platform may permit a client or sub-distributor to assign rates to DIDs that are reserved or activated by downstream sub-distributors. Each DID may be assigned a different rate structure, and may have different rates associated with reserving or activating the DID. FIG. 15 illustrates an example 1500 of this downstream billing structure for a group of distributors and their DIDs. Each distributor has a list of numbers or DIDs, with these DIDs made available to one or more distributors. Each DID is associated with a reserved rate and an activated rate, which are charged to the downstream sub-distributors that access those DIDs. Sub-distributors maintain an additional division of activated rates for a given DID, with a distributor activated rate being charged to downstream sub-distributors that access the DID, and a general activated rate that is charged to an end-user that obtains the DID directly from the sub-distributor. A DID number may be made available to several sub-distributors but may only be charged to the sub-distributors that actually activate or reserve the DID.

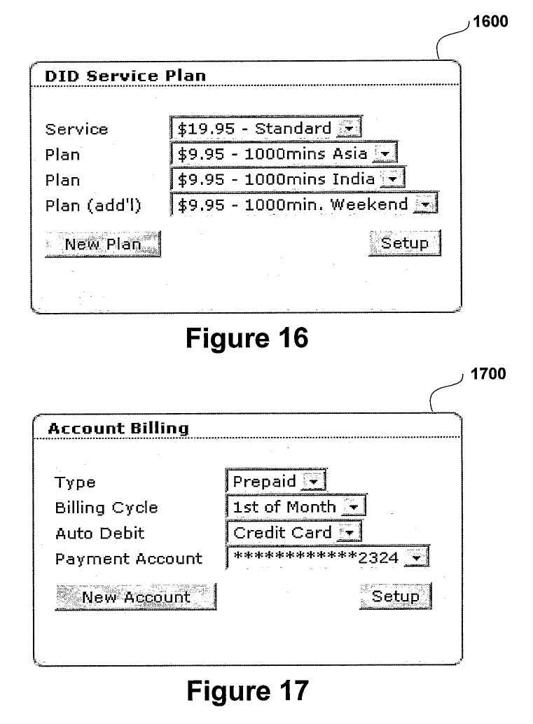

The platform may also provide the ability to create service plans that can be associated with a single DID or batch of DIDs. FIG. 16 illustrates an example 1600 of an interface that may be used to select or create a billing plan for this purpose. This may be used to provide pricing for outbound per-minute usage charges. Additionally, a service plan may be applied to inbound per-minute calling to toll-free numbers. A standard service fee may selected for a given DID, along with any standard plans that may charge on a per-usage or per-minute basis. The inbound billing services provided by the platform may permit clients or sub-distributors to create their own plans and mark up these plans as the DIDs are handed off down the distribution chain for each intermediary.

Additionally, the platform may provide adjustable billing cycles for sub-distributors and end-users. FIG. 17 illustrates an interface 1700 that may be used to configure automatic account billing cycles for a given sub-distributor or end-user. A pre-paid or post-paid type of billing may be selected for the account, along with the period of billing cycle. Generally a monthly cycle may be used, although other periods such as weekly or bi-weekly may be used as well. For a monthly billing cycle, a sub-distributor or end-user may be billed on the monthly anniversary of the day on which the account was provisioned; thus, if an account commenced service on the 20^{th} of a month, that account would always be billed on the 20^{th} of each month. Alternatively, the account may be billed on the first of every month, or other day, with pro-rated billing being applied for the partial month which occurs on commencement of service. In addition, the administrative platform may manage prepayments for usage of telephony services, so that fees are deducted before the billing cycle, and deductions from the end users' accounts are made immediately after each call. If the end user account is either pre-paid or has a credit limit, then calls cannot be placed if the end user does not have available credit. With real-time billing and credit limits, each level of the distribution network can be protected from either excessive charges or usage above credit limits from either the end users or sub-distributors. In addition, plans could include buckets of minutes, unlimited calling to certain destinations, or other aspects.

### 5. Account Management Tools

In addition to DID management and providing billing for DID plans and features, the administrative platform may provide a suite of administrative tools to provide client, sub-distributor, and end-user support. These additional tools may include search interfaces, report generation interfaces, and batch account management. These tools may be restricted by the client account to only certain sub-distributors, or may be provided to sub-distributors at an additional fee.

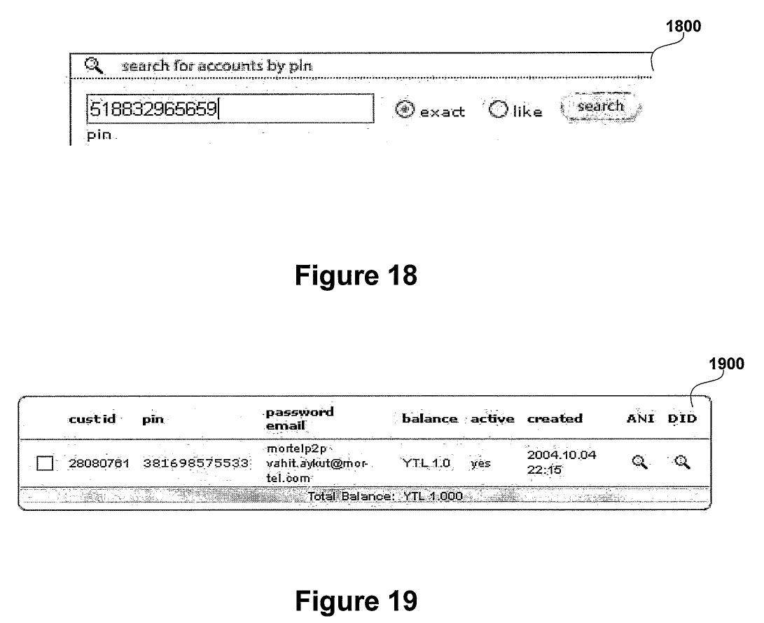

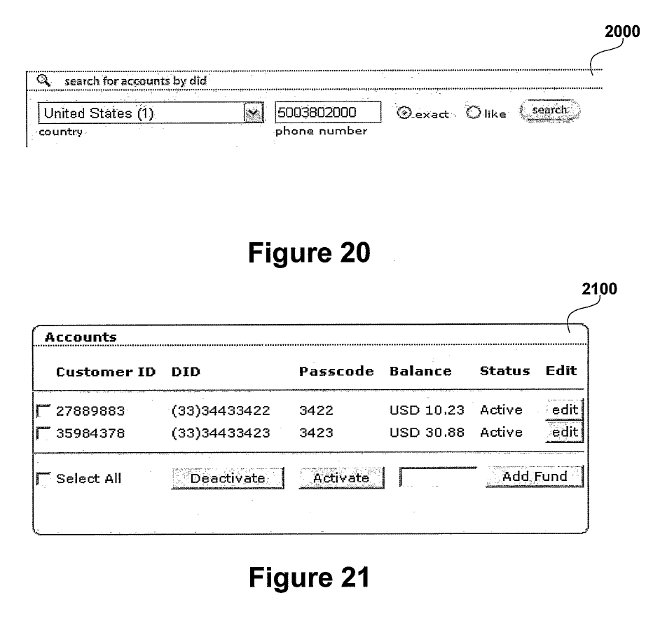

The platform may provide search tools to search for account balances based on such identifiers as a personal identification number (PIN) or DID. For example, a client or sub-distributor may search for an account by PIN number using an interface 1800 similar to the one illustrated in FIG. 18. It may be possible to search for accounts that match the PIN exactly, or return a list of accounts that have PINs similar to the search term. Any results may be returned and conveyed via an interface 1900 similar to the one illustrated in FIG. 19. Alternatively, a client or sub-distributor may search for an account by DID number using an interface 2000 similar to the one illustrated in FIG. 20. Again, it may be possible to search for accounts that match the DID exactly, or return a list of accounts that have DIDs similar to the search term. Any results may be returned and conveyed via an interface 2100 similar to the one illustrated in FIG. 21.

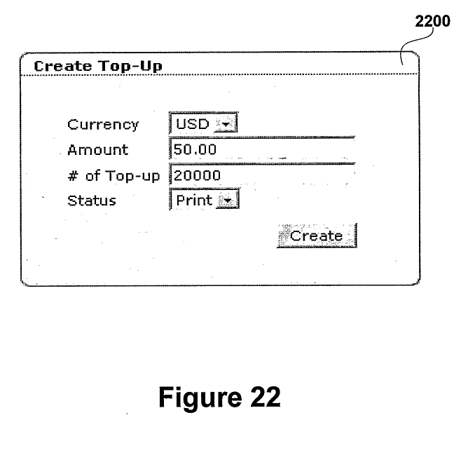

Additionally, a client or sub-distributor may be able to create a set of top-up cards to provide end-users with a simple way to apply credit towards their accounts. Using an interface 2200 similar to that of FIG. 22 a client or sub-distributor may print a given number of top-up cards with an associated credit. These top-up cards may be distributed or sold to end-users who may then apply the credit on the top-up cards towards their accounts with the associated client or sub-distributor.

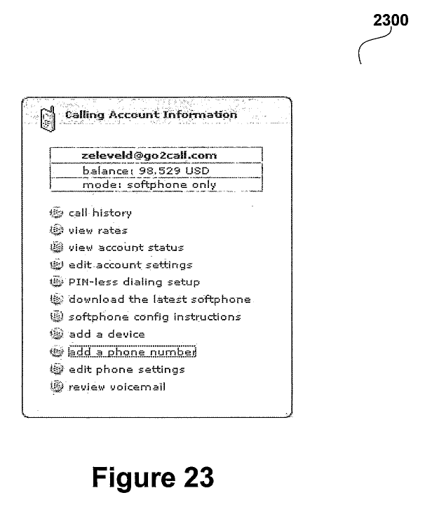

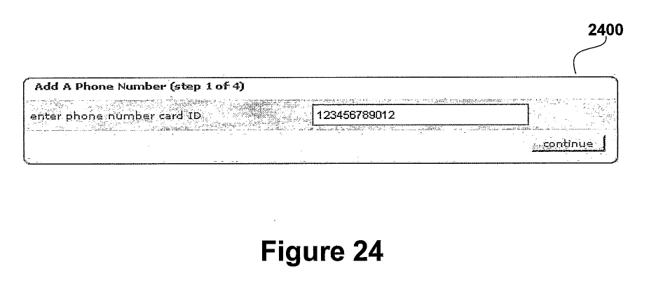

Further, a client or sub-distributor may also be able to create top-up PINs that allow end users to activate in-bound DID services. These top-up PINs facilitate the sale of DID services on a pre-paid basis, where the client or sub-distributor could create and print a DID card and then sell it to a retail distribution channel. Another benefit of a top-up PIN that enables DID services is that the client or sub-distributor can sell DID services without having a direct billing arrangement with the end user. After logging into the end user account, the end users may see an interface 2300 similar to that shown in FIG. 23, where the end user has the option to add a telephone number to their account. FIG. 24 illustrates an interface 2400 where an end user could enter the top-up PIN to activate in-bound DID telephone services.

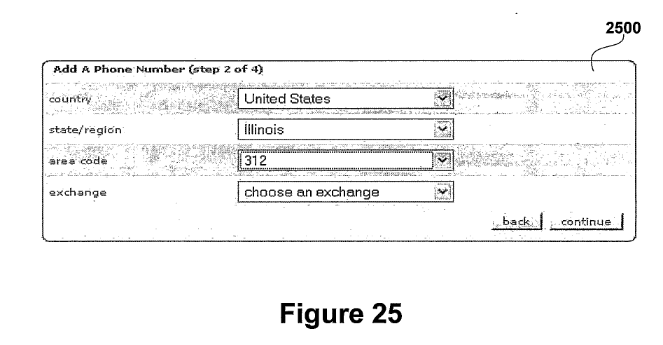

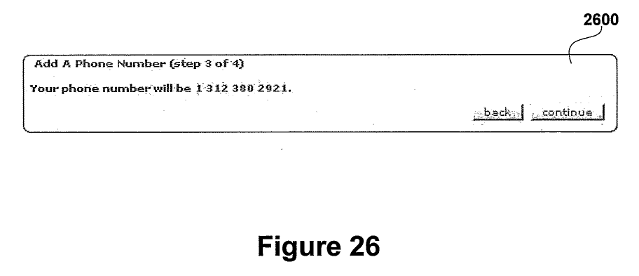

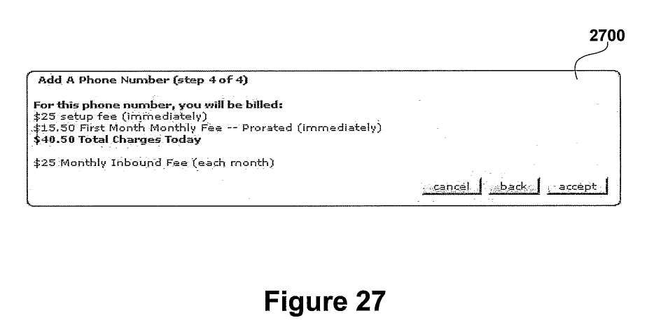

Upon successfully entering a valid PIN, users could be presented with an interface 2500 listing of choices for the telephone number that are associated with either the PIN, distributor account, or end user as shown in FIG. 25. For example, the end user could select a country or city where they would like the telephone number to be located. Based upon the end user criteria, an in-bound telephone number can be proposed in an interface 2600 like that shown in FIG. 26, with the option to go back and select different selection criteria if the end user does not like the telephone number allocated. Upon selecting the telephone number, FIG. 27 is an example interface 2700 for presenting the billing information to the end user.

In view of the wide variety of embodiments to which the principles of the invention can be applied, it should be understood that the illustrated embodiments are exemplary only, and should not be taken as limiting the scope of the present invention. For example, the term DID may be taken to include international toll-free (ITFS), local toll-free numbers, or even SIP uniform resource locators (URLs) for calling directly from other devices connected to the packet switched network. Furthermore, the inbound administration platform may be used to supplement an outbound administration platform, or as a standalone management system. In addition, the present invention can be practiced with a combination of software and hardware. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

We claim:

1. A data network telephony administration platform comprising:
one or more distributor accounts, comprising:
a master distributor account; and
one or more sub-distributor accounts, wherein each sub-distributor account comprises a set of sub-distributor direct-inward-dialing numbers (DIDs),
wherein a portion of the sub-distributor DIDs are provisioned by a distributor account;
one or more end-user accounts, wherein each end-user account comprises a set of end-user DID numbers, and wherein the end-user DIDs are provisioned by a distributor account;
a master set of DIDs, wherein the master set is provisioned by a telephony service provider and represents a set of available DIDs; and
an inbound services infrastructure, wherein the inbound services infrastructure facilitates telephony service to one or more end-user devices, wherein each of the one or more end-user devices is assigned a unique direct-inward-dialing number (DID).

2. The data network telephony administration platform of claim 1 wherein the sub-distributor DIDs comprise:
a set of available DIDs;
a set of reserved DIDs; and
a set of activated DIDs.

3. The data network telephony administration platform of claim 1 wherein a portion of the sub-distributor DIDs are provisioned by the parent distributor account of the sub-distributor.

4. The data network telephony administration platform of claim 3 wherein the portion of sub-distributor DIDs that are provisioned by the parent distributor account of the sub-distributor derive from the set of available DIDs of the parent distributor account.

5. The data network telephony administration platform of claim 1 wherein the DIDs comprise toll-free numbers.

6. The data network telephony administration platform of claim 2 wherein the set of available DIDs, set of reserved DIDs, and set of activated DIDs comprise DID numbers from the master set.

7. The data network telephony administration platform of claim 2 wherein the set of available DIDs, set of reserved DIDs, and set of activated DIDs comprise DID numbers from a third-party DID provider that differs from the telephony service provider.

8. A hosted multi-tiered administration platform for a packet-switched telephony system comprising:
a plurality of distributor accounts comprising:
a master account; and
one or more sub-distributor accounts, wherein each sub-distributor account is a client of a parent account,
wherein each parent account is one of the plurality of distributor accounts; and
one or more end-user accounts,
wherein each end-user account is the client of a distributor account;
wherein each distributor account manages a set of direct-inward-dialing numbers (DIDs), and wherein a subset of these DIDs are available DIDs that can be provisioned to a downstream sub-distributor or client;
wherein the DIDs managed by the master account comprise a master set of DIDs; and
wherein the DIDs managed by each sub-distributor account are provisioned by the parent account of the sub-distributor.

9. The platform of claim 8 wherein the DIDs managed by each sub-distributor contain subsets of reserved DIDs and activated DIDs, wherein the reserved DID numbers are not actively supported by the packet-switched telephony system, and wherein the activated DID numbers are actively supported by the packet-switched telephony system.

10. The platform of claim 9 wherein the activated DID numbers are assigned to one or more end-user accounts, and wherein each DID number corresponds to an internet telephony device.

11. A method for managing inbound data network telephony services, comprising:
creating a master account for managing inbound calling services;
acquiring a master set of direct-inward-dialing (DID) numbers;
creating one or more sub-distributor accounts; and
provisioning a sub-set of the master set of DID numbers to the one or more sub-distributor accounts.

12. The method of claim 11, further comprising:
activating at least one of the sub-set of the master set of DID numbers; and
assigning the activated at least one of the DID numbers to one or more end-user accounts, wherein each DID number corresponds to an internet telephony device.

13. The method of claim 11, further comprising displaying a user interface on a web browser, wherein the user interface allows a user to create at least one of the master account and at least one of the one or more sub-distributor accounts.

14. The method of claim 11, further comprising assigning the DID numbers to VoIP devices.

15. The method of claim 14, wherein the VoIP devices operate according to a protocol selected from the group consisting of SIP, H.323, and MGCP.

16. A method for managing inbound data network telephony services, comprising:
creating a master account for managing inbound calling services;
acquiring a master set of direct-inward-dialing (DID) numbers;
creating one or more sub-distributor accounts;
provisioning a sub-set of the master set of DID numbers to the one or more sub-distributor accounts; and
creating one or more end user accounts wherein each end user account comprises a set of end user DID numbers, and wherein the end-user DIDs are provisioned by a distributor account.

17. The method of claim 16, further comprising displaying a user interface on a web browser, wherein the user interface allows a user to create at least one of the master account and at least one of the one or more sub-distributor accounts.

18. The method of claim 16, further comprising assigning the DID numbers to VoIP devices.

19. The method of claim 18, wherein the VoIP devices operate according to a protocol selected from the group consisting of SIP, H.323, and MGCP.

20. A method of managing inbound data network telephony services, comprising:
creating a master account for managing inbound calling services;
acquiring a master set of direct-inward-dialing (DID) numbers;
creating top-up PINS for end users to associate DID numbers to corresponding accounts; and
providing an interface for an end user to enter a PIN and select a DID number.
